(19) United States
(12) Patent Application Publication
(10) Pub. No.: US 2026/0183866 A1
(43) Pub. Date: Jul. 2, 2026

(54) LASER DRILLING SYSTEM AND METHOD FOR SELECTIVE REMOVAL OF INSULATING LAYERS

(71) Applicant: Absolics Inc., Covington, GA (US)

(72) Inventors: Chun Jae LEE, Covington, GA (US); YONG HA WOO, Covington, GA (US); Tae Kyoung KIM, Covington, GA (US); Hideto MORI, Covington, GA (US)

(73) Assignee: Absolics Inc., Covington, GA (US)

(21) Appl. No.: 19/433,082

(22) Filed: Dec. 26, 2025

Related U.S. Application Data
(60) Provisional application No. 63/740,332, filed on Dec. 31, 2024.
(60) Provisional application No. 63/740,333, filed on Dec. 31, 2024.

(51) Int. Cl. B23K 26/03; B23K 26/064; B23K 26/362

(52) U.S. Cl. CPC B23K 26/032; B23K 26/064; B23K 26/362

(57) ABSTRACT

The embodiment relates to a laser drilling system and a method for selectively removing an insulating layer on a metal layer. The system comprises a processing target, a stage, a laser beam generator, and an optical delivery system that delivers laser light to the insulating layer through a mask. A monitoring and inspection device acquires surface-profile information of the processing target, and a control device uses the information to control the laser light and/or the optical delivery system. A blowing-suction device may be disposed between the processing target and the optical delivery system to remove particulate contaminants or smear generated during etching. The mask includes, in a top view, a light transmission region and one or more phase shift regions that transmit the laser light and output depth-etching lasers having different intensities, and a light-shielding region that blocks the laser light.

### CROSS-REFERENCE TO RELATED APPLICATION

This application claims priorities of U.S. Provisional Patent Application No. 63/740,332 , filed on Dec. 31, 2024, and No. 63/740,333, filed on Dec. 31, 2024, the entire disclosure of which are hereby incorporated by reference for all purposes.

### BACKGROUND

### Technical Field

The embodiment relates to a laser drilling system and a method for selectively removing an insulating layer, which can simplify a process so as to be efficiently performed, and which can form an intended hole shape even in cases where it is difficult to form the intended hole shape by a general exposure technique, such as a small hole or a high aspect ratio.

### Description of Related Art

In a manufacturing process for electronic components, front-end (FE) operations can implement circuits on semiconductor wafers, and back-end (BE) operations can assemble the wafers into a state usable as actual products. A packaging process may be included in the back-end operations.

Recently, four core technologies in the semiconductor industry that have enabled dramatic advances in electronic products may be regarded as semiconductor technology, semiconductor packaging technology, semiconductor manufacturing technology, and software technology.

Semiconductor technology has advanced in various areas such as sub-micron/nano-scale line widths, ten million or more cells, high-speed operation, and heat dissipation. However, complete packaging technology may not be sufficiently supported. Accordingly, the electrical performance of a semiconductor may be determined not only by the performance of the semiconductor technology itself but also by packaging technology and electrical interconnections accordingly.

One of the methods introduced to improve electrical performance is vertical interconnection. A via is one example of such a vertical interconnection structure, and laser drilling may be applied to form the via. When forming a small via, if a lithography scheme such as exposure and development is used, technical difficulties may arise as the depth of a via hole increases. For example, since it is difficult to reliably secure a hole profile such as a hole opening size and an aspect ratio, an additional operation such as plasma etching needs to be added, which causes difficulties such as increased complexity of operations and equipment and reduced yield.

Meanwhile, the background technology described above is technical information that the inventor possessed for deriving the present invention or acquired in the process of deriving the present invention, and thus is not necessarily publicly known technology disclosed to the general public before the filing of the present application.

Related art includes Korean Registered Patent Nos. 10-1496843 and 10-1690874, and Korean Laid-open Patent Publication Nos. 10-2022-0041219 and 10-2018-0010242.

### SUMMARY

This summary is provided to describe, in a simplified form, some concepts that are further described in more detail in the detailed description below. This summary is not intended to identify key features or essential features of the claimed subject matter, nor is it intended to be used to determine the scope of the claimed subject matter.

In some embodiments, a laser drilling system and a method for selectively removing an insulating layer, which can simplify a process so as to be efficiently performed are provided. In addition, in some embodiments, a laser drilling system capable of practically implementing patterns having different shapes, sizes, and depths, such as lines, holes, and pads, through substantially a single laser drilling operation are provided. In some embodiments, a laser drilling system capable of forming an intended hole shape even in cases where it is difficult to form the intended hole shape by a general exposure technique, such as a small hole or a high aspect ratio are also provided.

A laser drilling system according to one embodiment comprises: a processing target including a metal layer and an insulating layer disposed over the metal layer; a stage on which the processing target is disposed; a laser beam generator configured to output laser light; an optical delivery system disposed between the processing target and the laser beam generator and configured to allow the laser light to pass through a mask and be selectively delivered to the insulating layer; a monitoring and inspection device configured to inspect a surface profile of the processing target; and a control device configured to control laser light generated from the laser beam generator, the optical delivery system, or both of them, by reflecting the surface-profile information.

The mask may comprise, in a top view: a light transmission region that transmits the laser light and irradiates, toward the insulating layer, a first depth-etching laser having a first intensity; a phase shift region A that transmits the laser light and irradiates, toward the insulating layer, a second depth-etching laser having a second intensity; and a light-shielding region that blocks the laser light.

A via hole may be formed in the insulating layer corresponding to the light transmission region.

The mask may further comprise, in a top view, a phase shift region B that transmits the laser light and irradiates, toward the insulating layer, a third depth-etching laser having a third intensity.

The mask may comprise, in a cross-sectional view: a light-transmitting layer that transmits the laser light; a first phase shift layer disposed over the light-transmitting layer and configured to control a phase and an intensity of the laser light so as to irradiate, toward the insulating layer, a second depth-etching laser having the second intensity; and a light-shielding layer disposed over the first phase shift layer and configured to block the laser light.

The first phase shift layer and the light-shielding layer may be selectively etched to implement a pattern to be formed in the insulating layer.

The mask may comprise, in a cross-sectional view: a light-transmitting layer that transmits the laser light; a first phase shift layer disposed over the light-transmitting layer and configured to control the phase and the intensity of the laser light so as to irradiate, toward the insulating layer, a second depth-etching laser having the second intensity; a second phase shift layer disposed over the first phase shift layer and configured to control the phase and the intensity of the laser light; and a light-shielding layer disposed over the second phase shift layer and configured to block the laser light.

Laser light that has passed through the second phase shift layer and the first phase shift layer may have the phase and the intensity controlled to irradiate, toward the insulating layer, a third depth-etching laser having the third intensity, and the first phase shift layer, the second phase shift layer, and the light-shielding layer may be selectively etched to implement a pattern to be formed in the insulating layer.

The laser drilling system may further comprise a blowing-suction device disposed between the processing target and the optical delivery system.

In the insulating layer, a region etched by irradiation of the laser having the first intensity is a first depth-etching region, a region etched by irradiation of the laser having the second intensity is a second depth-etching region, and a region corresponding to the light-shielding region is a non-etched region. A height of the non-etched region is referred to as a reference height, a distance between the reference height and the first depth-etching region is a first etching depth, and a distance between the reference height and the second depth-etching region is a second etching depth, and the first etching depth may be greater than the second etching depth.

A bottom surface of the first depth-etching region may expose the metal layer.

A via electrode may be disposed in the first depth-etching region.

A conductive line may be disposed in the second depth-etching region.

The laser drilling system may simultaneously form, in the insulating layer, a pattern including a via hole having a controlled depth and diameter; a pad having a controlled depth and diameter; a line having a controlled depth and width; or all of them.

A laser drilling system according to an embodiment comprises: a processing target including a metal layer and an insulating layer disposed over the metal layer; a stage on which the processing target is disposed; an optical delivery system disposed over the stage and configured to deliver laser light to the insulating layer; a laser beam generator connected to the optical delivery system and configured to output laser light; a blowing-suction device disposed between the processing target and the optical delivery system; a monitoring and inspection device configured to inspect a surface profile of the processing target; and a control device configured to control laser light generated from the laser beam generator and/or the optical delivery system by reflecting the surface-profile information.

Laser light output from the laser beam generator is primary laser light, and light emitted from the optical delivery system toward the insulating layer is secondary laser light.

In the optical delivery system, the primary laser light may pass through the mask and be converted into the secondary laser light.

The laser light may form, in the insulating layer through the optical delivery system, a pattern including a via hole having a controlled depth and diameter; a pad having a controlled depth and diameter; a line having a controlled depth and width; or all of them.

The mask and the processing target may each have an alignment mark.

The control device may control positions of the mask and the processing target through the alignment marks.

The control device may control a processing height by the laser light.

The blowing-suction device may remove, from the insulating layer, particulate contaminants or smear generated when the insulating layer is removed by the laser light, using air pressure.

The control device may control temperature and humidity in the laser drilling system.

A method for selectively removing an insulating layer according to an embodiment comprises: a placement operation of disposing a processing target on a stage while controlling a position of the processing target relative to a mask of an optical delivery system; and an etching operation of causing primary laser light output from a laser beam generator to be incident on the mask and irradiating the processing target with laser light that has passed through the mask and is converted into secondary laser light.

The processing target may include a metal layer and an insulating layer disposed over the metal layer.

The secondary laser light may form, in the insulating layer, a pattern including a via hole, a pad, a line, or all of them.

The method for selectively removing the insulating layer may further comprise a particle removal operation simultaneously with, or after, the etching operation.

The particle removal operation may remove or collect particulate contaminants or smear by performing blowing, suction, or both on a surface of the processing target.

In the placement operation, the stage may fix the processing target by clamping or vacuum, and may dispose the processing target while relieving warpage.

A control operation is an operation of checking and controlling processing parameters.

The processing parameters may include processing drawing data having position alignment of the processing target, key checking of an alignment mark, a height of an etching target on the processing target, and processing purpose data.

The control operation may be controlled such that the etching operation is performed for holes, pads, and lines in a unit basis.

### BRIEF DESCRIPTION OF THE DRAWINGS

FIG. 1 is a conceptual cross-sectional view illustrating an etching operation performed in an optical delivery system according to an embodiment (top: a conceptual view illustrating a mask and laser light; middle: a graph showing an intensity of secondary laser light; bottom: a processing target before etching).

FIG. 2A is a view conceptually illustrating a cross-section of a mask according to an embodiment (top) and a graph showing an intensity of secondary laser light (bottom).

FIG. 2B is a view illustrating a graph showing an intensity of secondary laser light (top) and a conceptual cross-sectional view illustrating an etched processing target (bottom) according to an embodiment.

FIG. 3 is a conceptual cross-sectional view illustrating a process in which a processing target is etched according to an embodiment (top: a graph showing an intensity of secondary laser light; middle: an optical delivery system and a blowing-suction device; bottom: a processing target and particulate contaminants).

FIG. 4A is a conceptual cross-sectional view illustrating a processing target after etching according to an embodiment.

FIG. 4B is a conceptual cross-sectional view illustrating a state after additionally forming a metal layer on the processing target after etching according to an embodiment.

FIG. 5 is a conceptual view illustrating a laser drilling system according to an embodiment.

FIG. 6 is a conceptual cross-sectional view illustrating an etching operation performed in an optical delivery system according to an embodiment.

### DESCRIPTION OF THE EMBODIMENTS

The following detailed description is provided to assist a comprehensive understanding of the methods, apparatuses, and/or systems described herein. However, various changes, modifications, and equivalents of the methods, apparatuses, and/or systems described herein will become apparent after understanding the disclosure of the present application. For example, the order of operations described herein is merely illustrative and is not limited to the operations expressly described herein, but may be clearly changed after understanding the disclosure of the present application, except for operations that are necessarily performed in a specific order. Further, descriptions of known features may be omitted to enhance clarity and conciseness after understanding the disclosure of the present application, and such omission of features and descriptions is not an admission that the omitted matter is generally known.

The features described herein may be embodied in other forms and should not be construed as being limited to the examples described herein. Rather, the examples described herein are provided merely to illustrate some of many possible ways of implementing the methods, apparatuses, and/or systems described herein, which will become apparent after understanding the disclosure of the present application.

Terms such as “first,” “second,” and “third” may be used herein to describe various elements, elements, regions, layers, or sections, but such elements, elements, regions, layers, or sections are not limited by these terms. Rather, these terms are used to distinguish one member, part, region, layer, or section from another member, part, region, layer, or section. Thus, a first member, part, region, layer, or section referred to in an embodiment described herein may also be referred to as a second member, part, region, layer, or section without departing from the teachings of the embodiment.

Throughout the specification, when an element such as a layer, region, or substrate is described as being “on,” “connected to,” or “coupled to” another element, the element may be directly “on,” “connected to,” or “coupled to” the other element, or one or more intervening elements may be present therebetween. Conversely, when an element is described as being “directly on,” “directly connected to,” or “directly coupled to” another element, no intervening elements may be present therebetween. Similarly, expressions such as “between” and “directly between,” and “indirectly introduced” and “directly introduced” may be construed as described above.

The terminology used herein is for the purpose of describing particular examples only and is not intended to limit the present disclosure. As used herein, the singular forms “a,” “an,” and “the” may comprise the plural forms unless the context clearly indicates otherwise. As used herein, the term “and/or” comprises any one or more combinations of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof. As used herein with respect to an embodiment (for example, with respect to what an example or embodiment may include or may implement), the term “may” means that at least one example or embodiment exists in which such a feature is included or implemented, while all examples are not limited thereto.

Throughout the specification, “B disposed over A” means that B is disposed over A in direct contact with A or with one or more layers or structures interposed therebetween, and should not be construed as being limited to B being disposed over A in direct contact with A. Unless otherwise defined, all terms used herein have the same meaning as commonly understood by one of ordinary skill in the art to which this disclosure pertains, in view of the present document, and are consistent with such understanding after reading the present document.

Terms such as those defined in commonly used dictionaries should be construed to have meanings consistent with their meanings in the context of the related art and the present disclosure, and should not be construed in an idealized or overly formal sense unless expressly so defined herein.

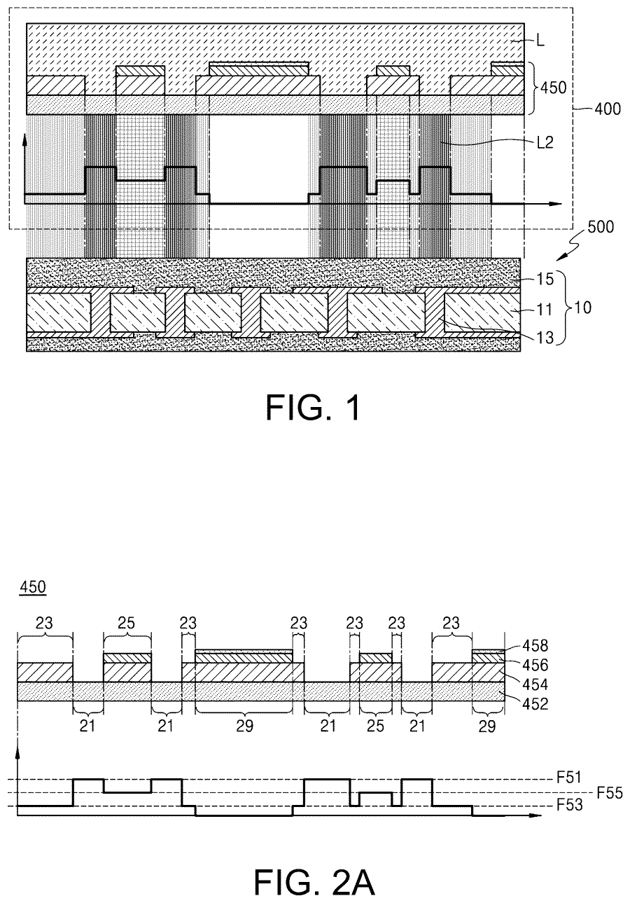

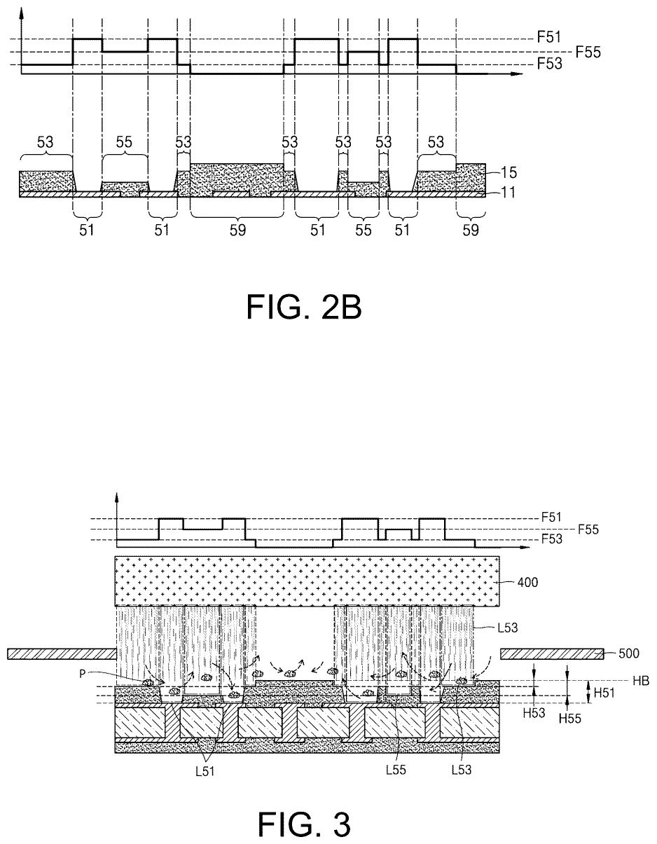

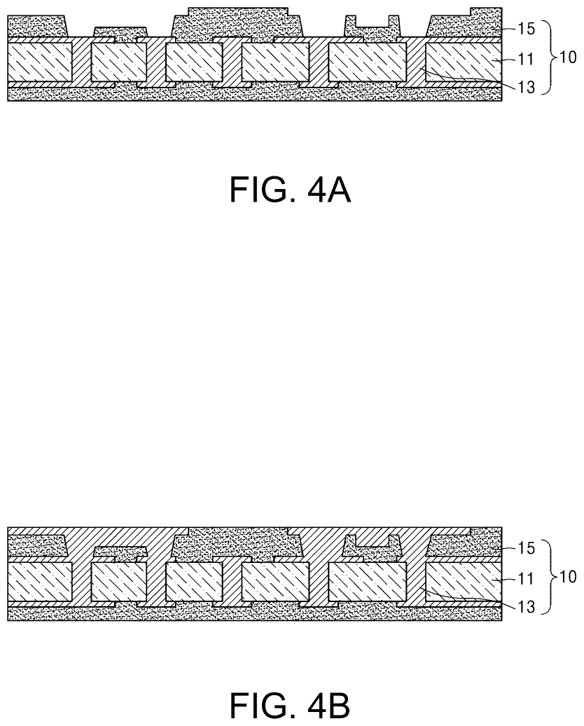

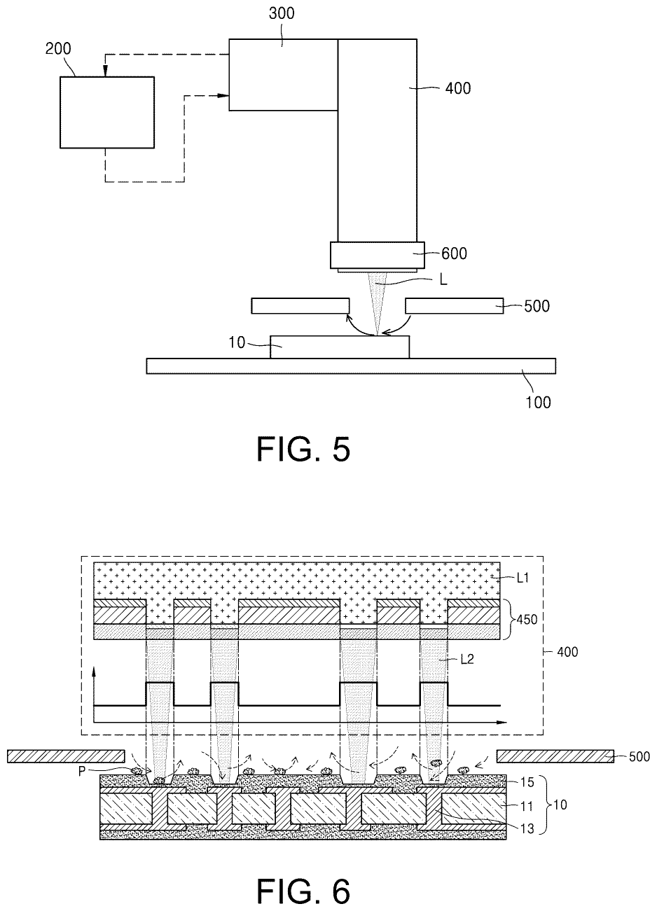

FIG. 1 is a conceptual cross-sectional view illustrating an etching operation performed in an optical delivery system according to an embodiment (top: a conceptual view illustrating a mask and laser light; middle: a graph showing an intensity of secondary laser light; bottom: a processing target before etching), and FIG. 5 is a conceptual view illustrating a laser drilling system according to an embodiment. FIG. 2A is a view conceptually illustrating a cross-section of a mask according to an embodiment (top) and a graph showing an intensity of secondary laser light (bottom), and FIG. 2B is a view illustrating a graph showing an intensity of secondary laser light (top) and a conceptual cross-sectional view illustrating an etched processing target (bottom) according to an embodiment. Further, FIG. 3 is a conceptual cross-sectional view illustrating a process in which a processing target is etched according to an embodiment (top: a graph showing an intensity of secondary laser light; middle: an optical delivery system and a blowing-suction device; bottom: a processing target and particulate contaminants). FIG. 4A is a conceptual cross-sectional view illustrating a processing target after etching according to an embodiment, and FIG. 4B is a conceptual cross-sectional view illustrating a state after additionally forming a metal layer on the processing target after etching according to an embodiment. With reference to the drawings, embodiments will now be described in further detail.

To achieve the above object, a laser drilling system according to an embodiment comprises a stage 100, an optical delivery system 400, a laser beam generator 300, a monitoring and inspection device 600, and a control device 200, and processes a processing target 10 (see FIG. 5). In detail, the components are connected to each other to perform selective etching of the processing target 10 within the laser drilling system.

The laser drilling system may further comprise a blowing-suction device 500.

The processing target 10 comprises a metal layer 13 and an insulating layer 15 disposed over the metal layer 13 (see the lower portion of FIG. 1).

By way of example, the processing target 10 may be a packaging substrate applied to packaging of semiconductor elements. When the processing target 10 is applied as the packaging substrate, a glass core 11 may be used. Specifically, the processing target 10 may comprise a glass core 11 having through vias, a metal layer 13 disposed on both surfaces of the glass core 11 and in the through vias, and an insulating layer 15 disposed over the metal layer 13.

The processing target 10 has the insulating layer disposed thereon, and the metal layer may be disposed over and/or under the insulating layer. Selective removal of the insulating layer enables a metal layer (electrically conductive layer) to be formed on the processing target 10 in a subsequent operation, and this may become a wiring pattern in the packaging substrate.

In a conventional process, formation of a metal layer (electrically conductive layer) required a considerably complex multi-step process.

Conventionally, to form a pattern including holes, pads, and lines on a processing target, such a process is performed as follows: 1) cleaning a substrate as a processing target; 2) forming a metal layer by sputtering or the like; 3) performing pretreatment; 4) performing a lithography process; 5) performing plating; 6) performing annealing and etching; 7) performing a cleaning process again; 8) performing pretreatment again; 9) disposing an insulating material; 10) curing the insulating material to manufacture an insulating layer; 11) forming via holes; 12) performing desmear; 13) performing cleaning; 14) forming a metal layer thereafter; 15) performing pretreatment; 16) performing a lithography process; 17) performing plating; and 18) repeating a process of performing annealing and etching to form one layer of a pattern.

In the embodiment, in removing portions of the insulating layer where a pattern is to be formed, holes, pads, lines, and the like may be processed through a laser drilling operation, rather than forming lines and holes separately as described above, thereby enabling simplification and efficiency of the process. When portions of the insulating layer where the pattern is to be formed are removed in this manner, a patterned metal layer may be efficiently formed by performing plating or the like thereon.

The stage 100 is a device on which the processing target 10 is disposed.

The processing target 10 may be disposed on the stage 100 by an automated device (for example, a robot arm), and the position after placement may be checked and corrected by the monitoring and inspection device 600 and the control device 200. In this case, an alignment mark (not shown) is disposed on the processing target 10, a relative position with respect to the stage 100 is detected by the monitoring and inspection device 600, and when the information is transmitted to the control device 200, the control device 200 may check whether the position is appropriate and adjust the position of the processing target 10.

The laser beam generator 300 is connected to the optical delivery system 400 and outputs laser light L.

The laser light L may have an absorptivity that enables processing of a metal material such as copper or titanium. In addition, the laser light L may have an absorptivity that enables processing of an organic layer or an organic-inorganic composite layer such as an insulating layer (e.g., a cured layer of Ajinomoto build-up film), a polyimide layer, or a photoresist layer.

Specifically, the laser light L may have a UV wavelength. For example, the laser light L may have a wavelength of 400 nm or less, 350 nm or less, 340 nm or less, 330 nm or less, 320 nm or less, 310 nm or less, 300 nm or less, 290 nm or less, 280 nm or less, 270 nm or less, 260 nm or less, or 250 nm or less. The laser light L may have a wavelength of 100 nm or more.

The laser light L may have a pulse energy of 10 mJ or more, 15 mJ or more, 20 mJ or more, 25 mJ or more, 30 mJ or more, 35 mJ or more, 40 mJ or more, 45 mJ or more, 50 mJ or more, 55 mJ or more, 60 mJ or more, 65 mJ or more, 70 mJ or more, or 75 mJ or more. The pulse energy may be 200 mJ or less, 150 mJ or less, or 1 J or less. When such pulse energy is applied, the insulating layer and the like may be removed more efficiently.

The laser light L may have a pulse repetition rate of 10 Hz or more, 50 Hz or more, 100 Hz or more, 300 Hz or more, 600 Hz or more, 900 Hz or more, 1,000 Hz or more, 2,000 Hz or more, 3,000 Hz or more, 4,000 Hz or more, or 5,000 Hz or more. The pulse repetition rate may be 10 kHz or less.

The laser light L may be processable in a high-resolution form while simultaneously applying a relatively high repetition rate and a relatively high energy.

In particular, the laser light L can reliably implement a via having a diameter of 20 μm or less when the depth is 20 μm or less.

The optical delivery system 400 is disposed on the stage 100 and delivers the laser light L to the insulating layer 15.

The laser light L is not delivered directly to the processing target 10, but laser light transformed through the optical delivery system 400 is delivered.

Laser light L output from the laser beam generator 300 is referred to as primary laser light, and light emitted from the optical delivery system 400 toward the insulating layer 15 is referred to as secondary laser light.

In the optical delivery system 400, the primary laser light passes through a mask 450 and is converted into secondary laser light.

The optical delivery system 400 is disposed between the processing target 10 and the laser beam generator 300, and allows the laser light L to pass through the mask 450 to deliver selectively converted laser light to the insulating layer 15.

Details of the mask and the laser light converted thereby will be described below.

The laser light L may form, in the insulating layer 15 through the optical delivery system 400, a pattern including a via hole having a controlled depth and diameter, a pad having a controlled depth and diameter, a line having a controlled depth and width, or all of them.

Formation of the pattern is performed by etching with the laser light. This pattern is formed by selectively removing a portion of the insulating layer. If particulate byproducts and the like remain in the etched pattern within the insulating layer, cleaning may become difficult in a subsequent operation, and disconnection may occur in a subsequent operation.

In an etching process by the laser light L, particulate contaminants or smear P, which are processing byproducts, may be generated. These need to be removed before proceeding with subsequent operations.

The laser drilling system may further comprise a blowing-suction device 500 disposed between the processing target 10 and the optical delivery system 400.

The blowing-suction device 500 removes, from the insulating layer 15 using air pressure, particulate contaminants or smear P generated when the insulating layer 15 is removed by the laser light L.

The blowing-suction device 500 is disposed between the processing target 10 and the optical delivery system 400. Such arrangement may facilitate removal of the particulate contaminants or smear.

For blowing, for example, gases such as CDA (Clean Dry Air) or N₂ may be applied, but the present disclosure is not limited thereto.

Such particulate byproducts or smear may be present in a part of the etched pattern and may fall onto and remain on the insulating layer. Optionally, a processing protection layer (not shown) may be disposed over the insulating layer, and accordingly, the particulate byproducts or smear may be removed more easily. Specifically, particulate byproducts or smear may be induced to fall onto the processing protection layer rather than directly onto the surface of the insulating layer. In subsequent operations, the particulate byproducts or smear may be more easily removed by removing the processing protection layer, and may also be easily removed in a cleaning operation by removing the processing protection layer.

The monitoring and inspection device 600 is a device configured to inspect surface-profile information of the processing target 10.

The control device 200 controls laser light L generated from the laser beam generator 300 and/or the optical delivery system 400 by reflecting the surface-profile information.

The monitoring and inspection device 600 and the control device 200 acquire information from the processing target and perform calculations based thereon to assist laser irradiation and selective removal of the insulating layer.

By way of example, the mask 450 and the processing target 10 may each have an alignment mark, and the control device 200 may control positions of the mask 450 and the processing target 10 through the alignment marks.

By way of example, the mask 450 and the processing target 10 may each have an alignment mark, and the control device 200 may control a processing height by the laser light L.

By way of example, the mask 450 and the processing target 10 may each have an alignment mark, and the control device 200 may control a spot size of the laser light L.

The control device 200 may control temperature and humidity in the laser drilling system.

By using the laser drilling system, etched patterns may be sequentially formed by dividing the insulating layer into regions, and the shape, width, and depth of the pattern may be controlled through control of the laser light, and laser drilling may be performed with high accuracy in a relatively short process time.

The control device 200 checks and controls processing parameters.

The processing parameters may include position alignment of the processing target 10, key checking of the alignment marks, a height of an etching target on the processing target 10, and processing drawing data having processing purpose data.

The control device 200 may control the etching such that holes, pads, and lines are processed in a unit basis.

A mask 450 according to an embodiment will now be described in detail.

The mask 450 comprises, in a cross-sectional view, a light-transmitting layer 452, a first phase shift layer 454, and a light-shielding layer 458. The mask 450 may further comprise, in a cross-sectional view, a second phase shift layer 456. The second phase shift layer 456 may be disposed between the first phase shift layer 454 and the light-shielding layer 458. These layers may be selectively etched to correspond to a pattern to be formed.

The light-transmitting layer 452 is a layer that transmits the laser light L. The light-transmitting layer transmits the laser light with only a minimal change in phase or intensity of the laser light.

The first phase shift layer 454 is disposed over the light-transmitting layer 452 and controls a phase and an intensity of the laser light L so as to irradiate, toward the insulating layer 15, a second depth-etching laser L53 having a second intensity F53.

The second phase shift layer 456 is disposed over the first phase shift layer 454 and is configured to control a phase and an intensity of the laser light L.

Laser light L that has passed through the second phase shift layer 456 and the first phase shift layer 454 may have the phase and the intensity controlled so as to irradiate, toward the insulating layer 15, a third depth-etching laser L55 having a third intensity F55.

The light-shielding layer 458 is disposed over the first phase shift layer 454 or over the second phase shift layer 456. The light-shielding layer substantially suppresses transmission of the laser light through the mask, and thus does not substantially induce etching in the insulating layer.

In the mask, the first phase shift layer 454 and the light-shielding layer 458 may be selectively etched to implement a pattern to be formed in the insulating layer 15.

In the mask, the first phase shift layer 454, the second phase shift layer 456, and the light-shielding layer 458 may be selectively etched to implement a pattern to be formed in the insulating layer 15.

The mask 450 comprises, in a top view, a light transmission region 21, a phase shift region A 23, and a light-shielding region 29. The mask 450 may further comprise, in a top view, a phase shift region B 25.

The light transmission region 21 transmits the laser light L and irradiates, toward the insulating layer 15, a first depth-etching laser L51 having a first intensity F51. The first depth-etching laser L51 may etch the insulating layer 15 to a first etching depth H51.

The phase shift region A 23 transmits the laser light L and irradiates, toward the insulating layer 15, a second depth-etching laser L53 having the second intensity F53. The second depth-etching laser L53 may etch the insulating layer 15 to a second etching depth H53.

The phase shift region B 25 transmits the laser light L and irradiates, toward the insulating layer 15, a third depth-etching laser L55 having the third intensity F55. The third depth-etching laser L55 may etch the insulating layer 15 to a third etching depth H55.

In the insulating layer 15, a region etched by irradiation of the laser having the first intensity F51 may form a first depth-etching region 51.

In the insulating layer 15, a region etched by irradiation of the laser having the second intensity F53 may form a second depth-etching region 53.

In the insulating layer 15, a region corresponding to the light-shielding region 29 may be a non-etched region 59.

In the insulating layer 15, a height of the non-etched region 59 is referred to as a reference height HB.

A distance between the reference height HB and the first depth-etching region 51 is a first etching depth H51.

A distance between the reference height HB and the second depth-etching region 53 is a second etching depth H53.

The first etching depth H51 may be greater than the second etching depth H53.

A distance between the reference height HB and the third depth-etching region 55 is a third etching depth H55.

The third etching depth H55 may be greater than the second etching depth H53.

A via hole may be formed in the first depth-etching region 51 of the insulating layer 15 corresponding to the light transmission region 21.

A bottom surface of the first depth-etching region 51 may expose the metal layer 13.

A via electrode may be disposed in the first depth-etching region 51.

A conductive line may be disposed in the second depth-etching region 53.

The via electrode, the conductive line, and the like may be implemented by forming a copper layer by an electroplating method or the like.

The laser drilling system may simultaneously form, in the insulating layer 15, a pattern including a via hole having a controlled depth and diameter, a pad having a controlled depth and diameter, a line having a controlled depth and width, or all of them.

The embodiment can provide a laser drilling system that can be simplified and efficiently performed. In addition, patterns having different shapes, sizes, and depths, such as lines, holes, and pads, can be practically implemented through substantially a single laser drilling operation.

FIG. 5 is a conceptual view illustrating a laser drilling system according to an embodiment, and FIG. 6 is a conceptual cross-sectional view illustrating an etching operation performed in an optical delivery system according to an embodiment. Hereinafter, embodiments will be described in further detail with reference to FIGS. 5 and 6.

To achieve the above object, a laser drilling system according to an embodiment comprises a stage 100, an optical delivery system 400, a laser beam generator 300, a blowing-suction device 500, a monitoring and inspection device 600, and a control device 200 (see FIG. 5).

The components are connected to each other to perform selective etching of a processing target 10 within the laser drilling system.

The processing target 10 comprises a metal layer 13 and an insulating layer 15 disposed over the metal layer 13 (see FIG. 6).

By way of example, the processing target 10 may be a packaging substrate applied to packaging of semiconductor elements. When the processing target 10 is applied as the packaging substrate, a glass core 11 may be used. Specifically, the processing target 10 may comprise a glass core 11 having through vias, a metal layer 13 disposed on both surfaces of the glass core 11 and in the through vias, and an insulating layer 15 disposed over the metal layer 13.

The processing target 10 has the insulating layer disposed thereon, and the metal layer may be disposed over and/or under the insulating layer. Selective removal of the insulating layer enables a metal layer (electrically conductive layer) to be formed on the processing target 10 in a subsequent operation, and this may become a wiring pattern in the packaging substrate.

In a conventional process, formation of a metal layer (electrically conductive layer) required a considerably complex multi-step process.

Conventionally, to form a pattern including holes, pads, and lines on a processing target, such a process is performed as follows: 1) cleaning a substrate as a processing target; 2) forming a metal layer by sputtering or the like; 3) performing pretreatment; 4) performing a lithography process; 5) performing plating; 6) performing annealing and etching; 7) performing a cleaning process again; 8) performing pretreatment again; 9) disposing an insulating material; 10) curing the insulating material to manufacture an insulating layer; 11) forming via holes; 12) performing desmear; 13) performing cleaning; 14) forming a metal layer thereafter; 15) performing pretreatment; 16) performing a lithography process; 17) performing plating; and 18) repeating a process of performing annealing and etching to form one layer of a pattern.

In the embodiment, in removing portions of the insulating layer where a pattern is to be formed, holes, pads, lines, and the like may be processed through a laser drilling operation, rather than forming lines and holes separately as described above, thereby enabling simplification and efficiency of the process. When portions of the insulating layer where the pattern is to be formed are removed in this manner, a patterned metal layer may be efficiently formed by performing plating or the like thereon.

The stage 100 is a device on which the processing target 10 is disposed.

The processing target 10 may be disposed on the stage 100 by an automated device (for example, a robot arm), and the position after placement may be checked and corrected by the monitoring and inspection device 600 and the control device 200. In this case, an alignment mark (not shown) is disposed on the processing target 10, a relative position with respect to the stage 100 is detected by the monitoring and inspection device 600, and when the information is transmitted to the control device 200, the control device 200 may check whether the position is appropriate and adjust the position of the processing target 10.

The laser beam generator 300 is connected to the optical delivery system 400 and outputs laser light L.

The laser light L may have an absorptivity that enables processing of a metal material such as copper or titanium. In addition, the laser light L may have an absorptivity that enables processing of an organic layer or an organic-inorganic composite layer such as an insulating layer (e.g., a cured layer of Ajinomoto build-up film), a polyimide layer, or a photoresist layer.

Specifically, the laser light L may have a UV wavelength. For example, the laser light L may have a wavelength of 400 nm or less, 350 nm or less, 340 nm or less, 330 nm or less, 320 nm or less, 310 nm or less, 300 nm or less, 290 nm or less, 280 nm or less, 270 nm or less, 260 nm or less, or 250 nm or less. The laser light L may have a wavelength of 100 nm or more.

The laser light L may have a pulse energy of 10 mJ or more, 15 mJ or more, 20 mJ or more, 25 mJ or more, 30 mJ or more, 35 mJ or more, 40 mJ or more, 45 mJ or more, 50 mJ or more, 55 mJ or more, 60 mJ or more, 65 mJ or more, 70 mJ or more, or 75 mJ or more. The pulse energy may be 200 mJ or less, 150 mJ or less, or 1 J or less. When such pulse energy is applied, the insulating layer and the like may be removed more efficiently.

The laser light L may have a pulse repetition rate of 10 Hz or more, 50 Hz or more, 100 Hz or more, 300 Hz or more, 600 Hz or more, 900 Hz or more, 1,000 Hz or more, 2,000 Hz or more, 3,000 Hz or more, 4,000 Hz or more, or 5,000 Hz or more. The pulse repetition rate may be 10 kHz or less.

The laser light L may be processable in a high-resolution form while simultaneously applying a relatively high repetition rate and a relatively high energy.

The laser light L can reliably implement a via having a diameter of 20 μm or less, particularly when the depth is 20 μm or less.

The optical delivery system 400 is disposed on the stage 100 and delivers the laser light L to the insulating layer 15.

The laser light L is not delivered directly to the processing target 10, but laser light transformed through the optical delivery system 400 is delivered.

Laser light L output from the laser beam generator 300 is referred to as primary laser light L1, and light emitted from the optical delivery system 400 toward the insulating layer 15 is referred to as secondary laser light L2.

In the optical delivery system 400, the primary laser light L1 passes through a mask 450 and is converted into secondary laser light L2.

The mask 450 is formed by etching a blank mask to have an intended pattern and is also referred to as a photomask. The mask 450 controls the primary laser light L1 passing therethrough such that laser light is emitted in an intended shape and intensity, and the emitted secondary laser light L2 is delivered to the processing target 10.

The laser light L may form, in the insulating layer 15 through the optical delivery system 400, a pattern including a via hole having a controlled depth and diameter, a pad having a controlled depth and diameter, a line having a controlled depth and width, or all of them.

Formation of the pattern is performed by etching with the laser light. This pattern is formed by selectively removing a portion of the insulating layer. If particulate byproducts and the like remain in the etched pattern within the insulating layer, cleaning may become difficult in a subsequent operation, and disconnection may occur in a subsequent operation.

In an etching process by the laser light L, particulate contaminants or smear P, which are processing byproducts, are generated. These need to be removed before proceeding with subsequent operations.

The blowing-suction device 500 removes, from the insulating layer 15 using air pressure, particulate contaminants or smear P generated when the insulating layer 15 is removed by the laser light L.

The blowing-suction device 500 is disposed between the processing target 10 and the optical delivery system 400. Such arrangement may facilitate removal of the particulate contaminants or smear.

For blowing, for example, gases such as CDA (Clean Dry Air) or N₂ may be applied, but the present disclosure is not limited thereto.

Such particulate byproducts or smear may be present in a part of the etched pattern and may fall onto and remain on the insulating layer. Optionally, a processing protection layer (not shown) may be disposed over the insulating layer, and accordingly, the particulate byproducts or smear may be removed more easily. Specifically, particulate byproducts or smear may be induced to fall onto the processing protection layer rather than directly onto the surface of the insulating layer. In subsequent operations, the particulate byproducts or smear may be more easily removed by removing the processing protection layer, and may also be easily removed in a cleaning operation by removing the processing protection layer.

The monitoring and inspection device 600 is a device configured to inspect surface-profile information of the processing target 10.

The control device 200 controls laser light L generated from the laser beam generator 300 and/or the optical delivery system 400 by reflecting the surface-profile information.

The monitoring and inspection device 600 and the control device 200 acquire information from the processing target and perform calculations based thereon to assist laser irradiation and selective removal of the insulating layer.

By way of example, the mask 450 and the processing target 10 may each have an alignment mark, and the control device 200 may control positions of the mask 450 and the processing target 10 through the alignment marks.

By way of example, the mask 450 and the processing target 10 may each have an alignment mark, and the control device 200 may control a processing height by the laser light L.

By way of example, the mask 450 and the processing target 10 may each have an alignment mark, and the control device 200 may control a spot size of the laser light L.

The control device 200 may control temperature and humidity in the laser drilling system.

By using the laser drilling system, etched patterns may be sequentially formed by dividing the insulating layer into regions, and the shape, width, and depth of the pattern may be controlled through control of the laser light, and laser drilling may be performed with high accuracy in a relatively short process time.

A method for removing an insulating layer according to another embodiment comprises a placement operation and an etching operation, and etches an insulating layer of a processing target to form a recessed pattern.

In the placement operation, a processing target 10 is disposed on a stage 100 while controlling a position of the processing target 10 relative to a mask 450 of an optical delivery system 400.

The placement operation may comprise fixing the processing target 10 by clamping or vacuum using the stage 100 and relieving warpage.

The processing target 10 comprises a metal layer 13 and an insulating layer 15 disposed over the metal layer 13. The metal layer 13 may be an electrically conductive layer (i.e., a patterned metal layer) disposed under the insulating layer in a packaging substrate. Alternatively, the metal layer 13 may be a seed layer disposed under the insulating layer in the packaging substrate.

The insulating layer 15 may be an organic layer or an organic-inorganic composite layer. By way of example, the insulating layer may be provided by disposing a sheet-shaped insulating material together with a release film such as a PET film over the metal layer 13, performing pressure lamination, and then curing or semi-curing the sheet-shaped insulating material.

The release film such as the PET film may also be used as the processing protection layer described above, as needed.

In the etching operation, primary laser light L1 output from a laser beam generator 300 is incident on the mask 450, and laser light L that has passed through the mask 450 and is converted into secondary laser light L2 is irradiated onto the processing target 10.

The secondary laser light L2 forms, in the insulating layer 15, a pattern including a via hole, a pad, a line, or all of them.

The method for removing the insulating layer may further comprise a particle removal operation simultaneously with, or after, the etching operation.

The particle removal operation may remove or collect particulate contaminants or smear P by performing blowing, suction, or both on a surface of the processing target 10.

The control operation is an operation of checking and controlling processing parameters.

The processing parameters may include position alignment of the processing target 10, key checking of alignment marks, a height of an etching target on the processing target 10, and processing drawing data having processing purpose data.

The control operation may control the etching operation such that holes, pads, and lines are processed in a unit basis.

The laser drilling system according to the embodiment can simplify a process so as to be efficiently performed, and can practically implement patterns having different shapes, sizes, and depths, such as lines, holes, and pads, through substantially a single laser drilling operation. In addition, the laser drilling system can form an intended hole shape even in cases where it is difficult to form the intended hole shape by a general exposure technique, such as a small hole or a high aspect ratio.

The laser drilling system according to the embodiment and the method for selectively removing an insulating layer can simplify a process so as to be efficiently performed, and can form an intended hole shape even in cases where it is difficult to form the intended hole shape by a general exposure technique, such as a small hole or a high aspect ratio.

The following embodiments are explained in detail with reference to the accompanying drawings, so that those skilled in the art may readily practice the invention. Nevertheless, the invention may be embodied in various forms and is not confined to the specific examples provided herein. Throughout the specification, like reference numerals indicate like elements.

What is claimed is:

1. A laser drilling system, comprising:
a processing target comprising a metal layer and an insulating layer disposed over the metal layer;
a stage on which the processing target is disposed;
a laser beam generator configured to output laser light;
an optical delivery system disposed between the processing target and the laser beam generator and configured to allow the laser light to pass through a mask and be selectively delivered to the insulating layer;
a monitoring and inspection device configured to inspect a surface profile of the processing target; and
a control device configured to control laser light generated from the laser beam generator, the optical delivery system, or both of them, by reflecting surface-profile information,
wherein the mask comprises, in a top view:
a light transmission region configured to transmit the laser light and irradiate, toward the insulating layer, a first depth-etching laser having a first intensity;
a phase shift region A configured to transmit the laser light and irradiate, toward the insulating layer, a second depth-etching laser having a second intensity; and
a light-shielding region configured to block the laser light.

2. The laser drilling system of claim 1,
wherein the mask comprises, in a cross-sectional view:
a light-transmitting layer configured to transmit the laser light;
a first phase shift layer disposed over the light-transmitting layer and configured to control a phase and an intensity of the laser light so as to irradiate, toward the insulating layer, a second depth-etching laser having the second intensity; and
a light-shielding layer disposed over the first phase shift layer and configured to block the laser light,
wherein the first phase shift layer and the light-shielding layer are selectively etched to implement a pattern to be formed in the insulating layer.

3. The laser drilling system of claim 2,
wherein the mask comprises, in a cross-sectional view:
a light-transmitting layer configured to transmit the laser light;
a first phase shift layer disposed over the light-transmitting layer and configured to control a phase and an intensity of the laser light so as to irradiate, toward the insulating layer, a second depth-etching laser having the second intensity;
a second phase shift layer disposed over the first phase shift layer and configured to control the phase and the intensity of the laser light; and
a light-shielding layer disposed over the second phase shift layer and configured to block the laser light,
wherein laser light that has passed through the second phase shift layer and the first phase shift layer has the phase and the intensity controlled so as to irradiate, toward the insulating layer, a third depth-etching laser having a third intensity, and
wherein the first phase shift layer, the second phase shift layer, and the light-shielding layer are selectively etched to implement a pattern to be formed in the insulating layer.

4. The laser drilling system of claim 1, wherein, in the insulating layer,
a region etched by irradiation of the laser having the first intensity is a first depth-etching region,
a region etched by irradiation of the laser having the second intensity is a second depth-etching region,
a region corresponding to the light-shielding region is a non-etched region,
a height of the non-etched region is a reference height,
a distance between the reference height and the first depth-etching region is a first etching depth,
a distance between the reference height and the second depth-etching region is a second etching depth, and
the first etching depth is greater than the second etching depth.

5. The laser drilling system of claim 1, further comprising
a blowing-suction device disposed between the processing target and the optical delivery system.

6. The laser drilling system of claim 1,
wherein a via hole is formed in the insulating layer corresponding to the light transmission region.

7. The laser drilling system of claim 4, wherein a via electrode is disposed in the first depth-etching region, and a conductive line is disposed in the second depth-etching region.

8. A method for selectively removing an insulating layer, comprising:
a placement operation of disposing a processing target on a stage while controlling a position of the processing target relative to a mask of an optical delivery system; and
an etching operation of causing primary laser light output from a laser beam generator to be incident on the mask and irradiating the processing target with laser light that has passed through the mask and is converted into secondary laser light,
wherein the processing target comprises a metal layer and an insulating layer disposed over the metal layer, and
wherein the secondary laser light forms, in the insulating layer, a pattern including a via hole, a pad, a line, or all of them.

9. The method of claim 8, further comprising a particle removal operation simultaneously with, or after, the etching operation,
wherein the particle removal operation removes or collects particulate contaminants or smear by performing blowing, suction, or both on a surface of the processing target.

10. The method of claim 8, further comprising
a control operation of checking and controlling processing parameters,
wherein the processing parameters comprise position alignment of the processing target, key checking of alignment marks, a height of an etching target on the processing target, and processing drawing data having processing purpose data, and
wherein the control operation is controlled such that the etching operation is performed for holes, pads, and lines in a unit basis.
